(19) United States
(12) Patent Application Publication
(10) Pub. No.: US 2022/0212597 A1
(43) Pub. Date: Jul. 7, 2022

(54) SYSTEM OF CONTROLLING UNMANNED VEHICLE AND METHOD OF CONTROLLING UNMANNED VEHICLE

(71) Applicant: Komatsu Ltd., Tokyo (JP)

(72) Inventors: Tatsuya Shiga, Tokyo (JP); Kouichi Yamashita, Tokyo (JP); Katsuki Awamori, Tokyo (JP); Daisuke Tanaka, Tokyo (JP)

(73) Assignee: Komatsu Ltd., Tokyo (JP)

(21) Appl. No.: 17/607,117

(22) PCT Filed: May 25, 2020
(86) PCT No.: PCT/JP2020/020459

§ 371 Date: Oct. 28, 2021

(30) Foreign Application Priority Data
Jun. 3, 2019 (JP) 2019-103966

(51) Int. Cl. B60Q 1/34; G05D 1/00; G05D 1/02

(52) U.S. Cl. CPC B60Q 1/346; G05D 2201/021; G05D 1/0212; G05D 1/0061

(57) ABSTRACT

A system of controlling an unmanned vehicle includes: a travel course data acquisition unit that acquires travel course data including blinker data for controlling a blinker provided in an unmanned vehicle; an operation data acquisition unit that acquires operation data of a blinker operation device provided in the unmanned vehicle; and a blinker control unit that controls the blinker based on the blinker data acquired by the travel course data acquisition unit when the operation data is acquired by the operation data acquisition unit at a time when the unmanned vehicle operates based on the travel course data.

### FIELD

The present disclosure relates to a system of controlling an unmanned vehicle and a method of controlling the unmanned vehicle.

### BACKGROUND

An unmanned vehicle may be used in a wide-area work site such as a mine. The unmanned vehicle can operate in either of a manual mode or an automatic mode. In the manual mode, the unmanned vehicle is operated by the driving operation of a driver. In the automatic mode, the unmanned vehicle operates in an unmanned manner without depending on the driving operation of the driver.

### CITATION LIST

### Patent Literature

Patent Literature 1: JP 2015 056134 A

### SUMMARY

### Technical Problem

At a work site, not only an unmanned vehicle but a manned vehicle operate. When a blinker is provided in the unmanned vehicle, an operator on board the manned vehicle can recognize the travel direction of the unmanned vehicle. In contrast, if the blinker does not correctly operate, the operator on board the manned vehicle cannot correctly recognize the travel direction of the unmanned vehicle.

### Solution to Problem

According to an aspect of the present invention, a system of controlling an unmanned vehicle, the system comprises: a travel course data acquisition unit that acquires travel course data including blinker data for controlling a blinker provided in an unmanned vehicle; an operation data acquisition unit that acquires operation data of a blinker operation device provided in the unmanned vehicle; and a blinker control unit that controls the blinker based on the blinker data acquired by the travel course data acquisition unit when the operation data is acquired by the operation data acquisition unit at a time when the unmanned vehicle operates based on the travel course data.

### Advantageous Effects of Invention

According to the disclosure, a blinker of an unmanned vehicle can be correctly operated.

### BRIEF DESCRIPTION OF DRAWINGS

FIG. 1 schematically illustrates one example of a control system, an unmanned vehicle, and a manned vehicle according to an embodiment.

FIG. 2 schematically illustrates one example of a work site according to the embodiment.

FIG. 3 is a functional block diagram illustrating one example of a management device and a control device according to the embodiment.

FIG. 4 is a flowchart illustrating one example of a method of controlling the unmanned vehicle according to the embodiment.

FIG. 5 is a block diagram illustrating one example of a computer system.

### DESCRIPTION OF EMBODIMENTS

Hereinafter, although an embodiment of the disclosure will be described with reference to the drawings, the present invention is not limited to the embodiment. Components in the embodiment described below can be appropriately combined. Furthermore, some components are not used in some cases.

[Control System]

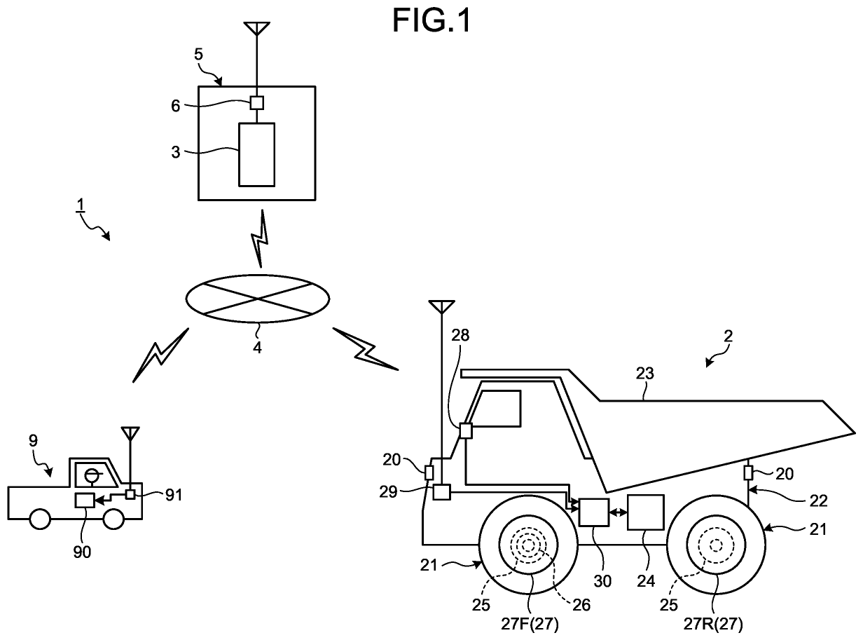

FIG. 1 schematically illustrates one example of a control system 1, an unmanned vehicle 2, and a manned vehicle 9 according to the embodiment. The unmanned vehicle 2 refers to a vehicle that can be operated in an unmanned manner without depending on a driving operation of a driver. The unmanned vehicle 2 operates at a work site.

The control system 1 includes a management device 3 and a communication system 4. The management device 3 includes a computer system, and is installed in, for example, a mine control facility 5. The communication system 4 performs communication between the management device 3 and the unmanned vehicle 2. A wireless communication device 6 is connected to the management device 3. The communication system 4 includes the wireless communication device 6. The management device 3 and the unmanned vehicle 2 wirelessly communicate with each other via the communication system 4.

[Unmanned Vehicle]

The unmanned vehicle 2 operates at a work site based on travel course data from the management device 3. The unmanned vehicle 2 includes a blinker 20, a travel device 21, a vehicle body 22, a dump body 23, and a control device 30. The travel device 21 supports the vehicle body 22. The vehicle body 22 supports the dump body 23.

The blinker 20 is a direction indicator that displays the travel direction of the unmanned vehicle 2. The blinker 20 is disposed at each of the front portion and the rear portion of the vehicle body 22. Operation of the blinker 20 notifies the surroundings of the travel direction of the unmanned vehicle 2. The blinker 20 includes a blinker lamp. The operation of the blinker 20 includes lighting or blinking of the blinker lamp. The operation stop of the blinker 20 includes lights-out of the blinker lamp. The blinker 20 includes a right blinker lamp and a left blinker lamp. The right blinker lamp lights or blinks when the unmanned vehicle 2 turns right. The left blinker lamp lights or blinks when the unmanned vehicle 2 turns left. The right blinker lamp is disposed at the right portion of the vehicle body 22. The left blinker lamp is disposed at the left portion of the vehicle body 22. Furthermore, the blinker 20 can perform hazard lighting in which the right blinker lamp and the left blinker lamp simultaneously light or blink.

The travel device 21 includes a drive device 24, a brake device 25, a steering device 26, and wheels 27. The drive device 24 drives the travel device 21. The brake device 25 brakes the travel device 21. The steering device 26 adjusts a travel direction.

Rotation of the wheels 27 causes the unmanned vehicle 2 to be self-propelled. The wheels 27 include a front wheel 27F and a rear wheel 27R. Tires are mounted on the wheels 27.

The drive device 24 generates driving force for accelerating the unmanned vehicle 2. The drive device 24 includes an internal combustion engine such as a diesel engine. Note that the drive device 24 may include an electric motor. Power generated by the drive device 24 is transmitted to the rear wheel 27R. The brake device 25 generates braking force for decelerating or stopping the unmanned vehicle 2. The steering device 26 can adjust the travel direction of the unmanned vehicle 2. The travel direction of the unmanned vehicle 2 includes the direction of the front portion of the vehicle body 22. The steering device 26 adjusts the travel direction of the unmanned vehicle 2 by steering the front wheel 27F.

The control device 30 is disposed in the unmanned vehicle 2. The control device 30 can communicate with the management device 3 outside the unmanned vehicle 2. The control device 30 outputs an accelerator command, a brake command, and a steering command. The accelerator command is output for operating the drive device 24. The brake command is output for operating the brake device 25. The steering command is output for operating the steering device 26. The drive device 24 generates driving force for accelerating the unmanned vehicle 2 based on the accelerator command output from the control device 30. The travel speed of the unmanned vehicle 2 is adjusted by adjusting the output of the drive device 24. The brake device 25 generates braking force for decelerating the unmanned vehicle 2 based on the brake command output from the control device 30. The steering device 26 generates force for changing the direction of the front wheel 27F based on the steering command output from the control device 30 so that the unmanned vehicle 2 moves straight or turns.

Furthermore, the unmanned vehicle 2 includes a position detection device 28 that detects the position of the unmanned vehicle 2. The position of the unmanned vehicle 2 is detected by using a global navigation satellite system (GNSS). The global navigation satellite system includes a global positioning system (GPS). The global navigation satellite system detects the absolute position of the unmanned vehicle 2 specified by coordinate data of latitude, longitude, and altitude. The position of the unmanned vehicle 2 specified in a global coordinate system is detected by the global navigation satellite system. The global coordinate system refers to a coordinate system fixed to the earth. The position detection device 28 includes a GNSS receiver, and detects the absolute position (coordinates) of the unmanned vehicle 2.

Furthermore, the unmanned vehicle 2 includes a wireless communication device 29. The communication system 4 includes the wireless communication device 29. The wireless communication device 29 can wirelessly communicate with the management device 3.

[Manned Vehicle]

The manned vehicle 9 is operated by a driving operation of an operator. The manned vehicle 9 includes a cab in which the operator boards. Furthermore, the manned vehicle 9 includes a control device 90 and a wireless communication device 91. The communication system 4 includes the wireless communication device 91. The wireless communication device 91 can wirelessly communicate with the management device 3.

[Work Site]

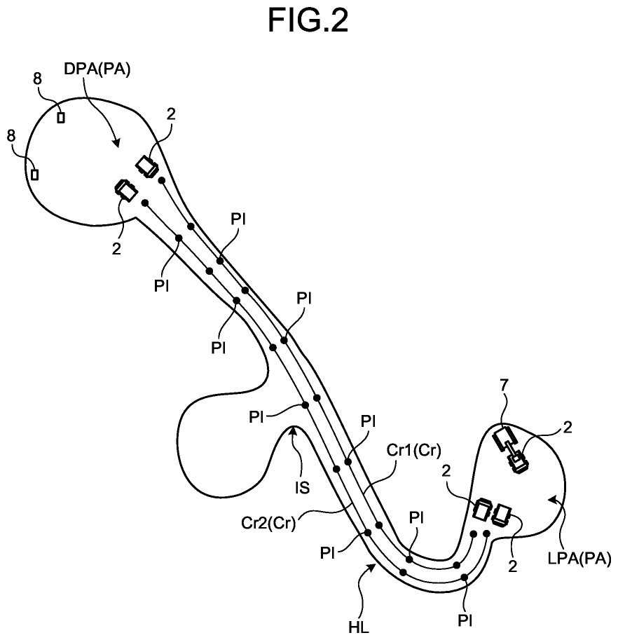

FIG. 2 schematically illustrates one example of a work site according to the embodiment. In the embodiment, the work site is a mine or a quarry. The unmanned vehicle 2 is a dump truck that travels in the work site and transports a cargo. The mine refers to a place or business facilities for mining minerals. Examples of the cargo transported by the unmanned vehicle 2 include ore and earth and sand excavated in the mine or the quarry.

The unmanned vehicle 2 travels through at least a part of a workplace PA and a travel path HL leading to the workplace PA in a mine. The workplace PA includes at least one of a loading place LPA and a discharging place DPA. The travel path HL includes an intersection IS.

The loading place LPA refers to an area where loading operation for loading a cargo on the unmanned vehicle 2 is performed. In the loading place LPA, a loader 7 such as an excavator operates. The discharging place DPA refers to an area where discharging operation for discharging a cargo from the unmanned vehicle 2 is performed. The discharging place DPA is provided with, for example, a crusher 8.

A target travel route Cr is set on the travel path HL and the workplace PA. The unmanned vehicle 2 travels on the travel path HL along the target travel route Cr. The target travel route Cr includes a target travel route Cr1 and a target travel route Cr2. For example, the unmanned vehicle 2 travels from the discharging place DPA to the loading place LPA along the target travel route Cr1, and travels from the loading place LPA to the discharging place DPA along the target travel route Cr2.

[Management Device and Control Device]

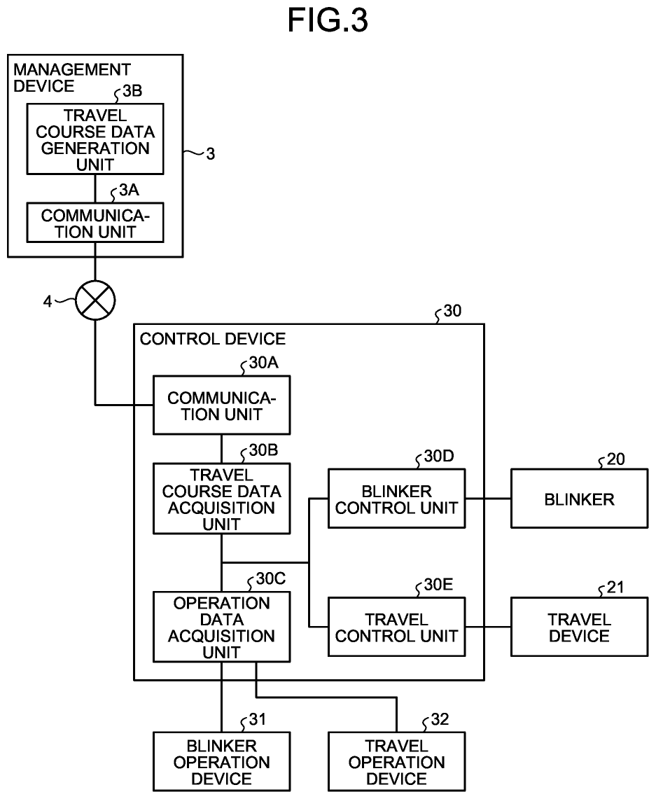

FIG. 3 is a functional block diagram illustrating one example of the management device 3, the control device 30, and the control device 90 according to the embodiment. The control device 30 can communicate with the management device 3 via the communication system 4.

The management device 3 includes a communication unit 3A and a travel course data generation unit 3B.

The communication unit 3A receives data transmitted from the control device 30 via the communication system 4. Furthermore, the communication unit 3A transmits data to the control device 30 via the communication system 4.

The travel course data generation unit 3B generates travel course data including the target travel route Cr of the unmanned vehicle 2. As illustrated in FIG. 2, the travel course data includes a plurality of points PI set at intervals. The target travel route Cr is specified by a line connecting the plurality of points PI. A target travel speed and a target travel orientation of the unmanned vehicle 2 are set at each of the plurality of points PI. Furthermore, the travel course data includes blinker data for controlling the blinker 20. The blinker data is set at each of the plurality of points PI. The blinker data indicates an operation condition of the blinker 20 when the unmanned vehicle 2 passes through a point PI. The blinker data includes operation start data for starting the operation of the right blinker lamp, operation start data for starting the operation of the left blinker lamp, operation stop data for stopping the operation of the right blinker lamp, and operation stop data for stopping the operation of the left blinker lamp. The travel course data generation unit 3B outputs the generated travel course data to the communication unit 3A. The communication unit 3A transmits the travel course data to the control device 30 of the unmanned vehicle 2.

In the embodiment, the unmanned vehicle 2 can operate in either of a manual mode or an automatic mode. In the manual mode, the unmanned vehicle 2 is operated by the driving operation of a driver on board the cab of the unmanned vehicle 2. In the automatic mode, the unmanned vehicle 2 operates in an unmanned manner based on the travel course data without depending on the driving operation of the driver. That is, the mode of the unmanned vehicle 2 is switched between the automatic mode and the manual mode.

The control device 30 is connected to each of a blinker operation device 31 and a travel operation device 32. Each of the blinker operation device 31 and the travel operation device 32 is provided in the unmanned vehicle 2. The unmanned vehicle 2 is provided with a cab on which the driver boards in the manual mode. Each of the blinker operation device 31 and the travel operation device 32 is disposed in the cab of the unmanned vehicle 2.

The blinker operation device 31 is operated to operate the blinker 20 and stop the operation of the blinker 20. A driver or an operator on board the cab of the unmanned vehicle 2 can operate the blinker operation device 31. The blinker operation device 31 includes a blinker lever with which the blinker 20 can be operated and the operation of the blinker 20 can be stopped. Furthermore, the blinker operation device 31 includes a hazard switch that causes the hazard lighting of the blinker 20. In the manual mode, the driver or the operator can operate the blinker 20 by operating the blinker operation device 31.

The travel operation device 32 is operated to operate the travel device 21 and stop operation of the travel device 21. The driver or the operator on board the cab of the unmanned vehicle 2 can operate the travel operation device 32. The travel operation device 32 includes an accelerator pedal, a brake pedal, and a steering wheel. The accelerator pedal adjusts the output of the drive device 24. The brake pedal operates the brake device 25. The steering wheel operates the steering device 26. In the manual mode, the driver or the operator can operate the travel device 21 by operating the travel operation device 32.

The control device 30 includes a communication unit 30A, a travel course data acquisition unit 30B, an operation data acquisition unit 30C, a blinker control unit 30D, and a travel control unit 30E.

The communication unit 30A transmits data to the management device 3 via the communication system 4. Furthermore, the communication unit 30A receives data transmitted from the management device 3 via the communication system 4.

The travel course data acquisition unit 30B acquires travel course data. The travel course data is transmitted from the management device 3, and includes blinker data for controlling the blinker 20 provided in the unmanned vehicle 2.

The operation data acquisition unit 30C acquires operation data of the blinker operation device 31 provided in the unmanned vehicle 2. Furthermore, the operation data acquisition unit 30C acquires operation data of the travel operation device 32 provided in the unmanned vehicle 2.

The blinker control unit 30D controls the blinker 20 of the unmanned vehicle 2. The blinker control unit 30D controls the operation of the blinker 20. When the unmanned vehicle 2 operates based on the travel course data, the blinker control unit 30D controls the blinker 20 based on the blinker data included in the travel course data.

For example, when the unmanned vehicle 2 is in the automatic mode, the blinker control unit 30D controls the blinker 20 based on the blinker data included in the travel course data acquired by the travel course data acquisition unit 30B.

When the unmanned vehicle 2 is in the manual mode, the blinker control unit 30D controls the blinker 20 based on the operation data generated by operation of the blinker operation device 31.

When the travel course data acquisition unit 30B acquires the blinker data and the operation data acquisition unit 30C acquires the operation data, that is, when both the blinker data and the operation data are simultaneously acquired, the blinker control unit 30D controls the blinker 20 based on the blinker data.

For example, when the unmanned vehicle 2 is in the automatic mode and the operation data acquisition unit 30C acquires the operation data of the blinker operation device 31, the blinker control unit 30D controls the blinker 20 based on the blinker data acquired by the travel course data acquisition unit 30B without depending on the operation data of the blinker operation device 31. That is, in the automatic mode, when the travel course data acquisition unit 30B acquires the blinker data and the operation data acquisition unit 30C acquires the operation data of the blinker operation device 31, the blinker control unit 30D controls the blinker 20 based on the blinker data without depending on the operation data.

For example, when the unmanned vehicle 2 operates based on the travel course data, the blinker operation device 31 may be operated. For example, when the unmanned vehicle 2 travels in the automatic mode for the first time in a work site, the unmanned vehicle 2 may travel in the automatic mode with a driver being on board the unmanned vehicle 2. When the unmanned vehicle 2 travels in the automatic mode with the driver being on board the unmanned vehicle 2, the driver may erroneously touch the blinker operation device 31 to move the blinker operation device 31. Furthermore, for example, vibration of the vehicle body 22 may move the blinker operation device 31. As described above, even when the blinker operation device 31 is operated in the automatic mode, the blinker control unit 30D controls the blinker 20 based on the blinker data transmitted from the management device 3. That is, when the unmanned vehicle 2 operates based on the travel course data and the operation data acquisition unit 30C acquires the operation data of the blinker operation device 31, the blinker control unit 30D controls the blinker 20 based on the blinker data transmitted from the management device 3 without depending on the operation data of the blinker operation device 31.

Note that, when the mode is switched from the manual mode to the automatic mode with the operation data of the blinker operation device 31 having been acquired by the operation data acquisition unit 30C, the blinker control unit 30D may control the blinker 20 by prioritizing the blinker data transmitted from the management device 3 over the operation data of the blinker operation device 31.

The travel control unit 30E controls the travel device 21 of the unmanned vehicle 2. The travel control unit 30E controls the travel of the unmanned vehicle 2. When the unmanned vehicle 2 is in the manual mode, the travel control unit 30E controls the travel of the unmanned vehicle 2 based on the operation data generated by operation of the travel operation device 32. When the unmanned vehicle 2 is in the automatic mode, the travel control unit 30E controls the travel of the unmanned vehicle 2 based on the travel course data acquired by the travel course data acquisition unit 30B.

[Control Method]

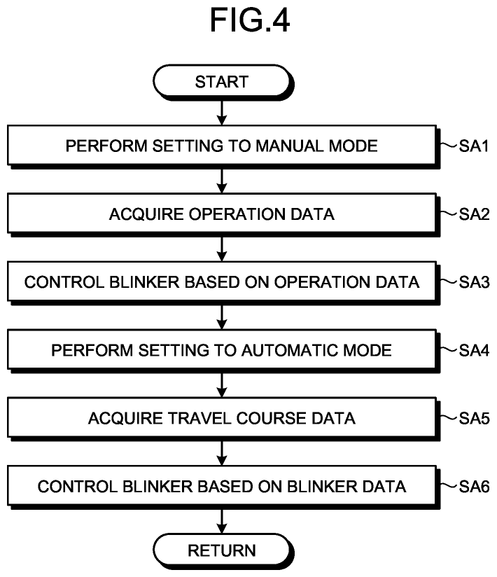

FIG. 4 is a flowchart illustrating one example of a method of controlling the unmanned vehicle 2 according to the embodiment. For example, in maintenance or the like of the unmanned vehicle 2, the unmanned vehicle 2 is set to the manual mode (Step SA1).

The blinker operation device 31 may be operated in the manual mode. For example, when the unmanned vehicle 2 is moved to a parking lot for maintenance, a driver may move the unmanned vehicle 2 to the parking lot while operating the blinker operation device 31 and the travel operation device 32. The operation data acquisition unit 30C acquires operation data of the blinker operation device 31 (Step SA2).

The blinker control unit 30D controls the blinker 20 based on the operation data acquired by the operation data acquisition unit 30C (Step SA3).

The mode of the unmanned vehicle 2 is set to the automatic mode (Step SA4).

In the management device 3, the travel course data generation unit 3B generates the travel course data including the blinker data. The communication unit 3A transmits the generated travel course data to the control device 30 of the unmanned vehicle 2 via the communication system 4.

In the control device 30, the travel course data acquisition unit 30B acquires the travel course data (Step SA5).

The unmanned vehicle 2 whose mode is set to the automatic mode starts the operation based on the travel course data. The travel control unit 30E controls the travel device 21 so that the unmanned vehicle 2 travels along the target travel route Cr specified by the travel course data. The blinker control unit 30D controls the blinker 20 based on the blinker data included in the travel course data (Step SA6).

Even when the blinker operation device 31 is operated and the operation data acquisition unit 30C acquires the operation data in the automatic mode, the blinker control unit 30D controls the blinker 20 based on the blinker data in the case where the unmanned vehicle 2 is operated based on the travel course data. That is, in the automatic mode, when the control device 30 acquires both the operation data and the blinker data of the blinker operation device 31, the blinker control unit 30D controls the blinker 20 based on the blinker data without depending on the operation data of the blinker operation device 31.

[Effects]

As described above, according to the embodiment, when the unmanned vehicle 2 operates based on the travel course data, and the control device 30 acquires both the operation data of the blinker operation device 31 and the blinker data from the management device 3, the blinker 20 is controlled based on the blinker data transmitted from the management device 3. As a result, the control device 30 can correctly operate the blinker 20 of the unmanned vehicle 2.

As described above, when the unmanned vehicle 2 operates based on the travel course data, the blinker operation device 31 may be operated by some reasons. If the blinker 20 is controlled based on the operation data of the blinker operation device 31, the blinker 20 may fail to correctly operate. For example, when the travel course data acquisition unit 30B acquires travel course data for turning the unmanned vehicle 2 to the left with the blinker operation device 31 being operated to operate the right blinker lamp, if the operation data of the blinker operation device 31 is prioritized in the automatic mode, the unmanned vehicle 2 turns left while the right blinker lamp is operated. As described above, if the blinker 20 does not correctly operate in the automatic mode, an operator on board the manned vehicle 9 or another operator in a work site may fail to correctly recognize the travel direction of the unmanned vehicle 2.

In the embodiment, even when the blinker operation device 31 is operated in the case where the unmanned vehicle 2 operates based on the travel course data, the blinker 20 is controlled based on the blinker data included in the travel course data. Since the blinker 20 is controlled based on the blinker data adapted to the target travel route Cr, the blinker 20 can correctly operate so as to be adapted to the target travel route Cr.

[Computer System]

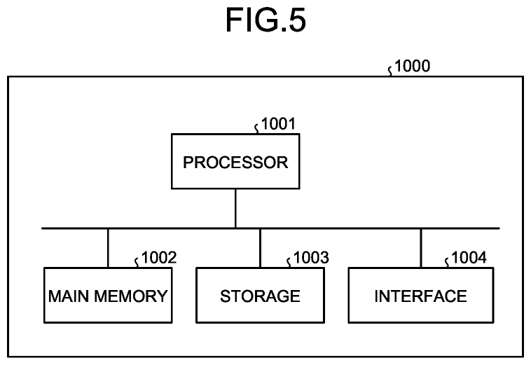

FIG. 5 is a block diagram illustrating one example of a computer system 1000. Each of the management device 3, the control device 30, and the control device 90 described above includes the computer system 1000. The computer system 1000 includes a processor 1001 such as a central processing unit (CPU), a main memory 1002, a storage 1003, and an interface 1004. The main memory 1002 includes a nonvolatile memory such as a read only memory (ROM) and a volatile memory such as a random access memory (RAM). The interface 1004 includes an input/output circuit. The function of the above-described management device 3 and the function of the control device 30 are stored in the storage 1003 as a program. The processor 1001 reads the program from the storage 1003, develops the program in the main memory 1002, and executes the above-described processing in accordance with the program. Note that the program may be distributed to the computer system 1000 via a network.

According to the above-described embodiment, the computer system 1000 can perform: acquiring travel course data including blinker data for controlling the blinker 20 provided in the unmanned vehicle 2; acquiring operation data of the blinker operation device 31 provided in the unmanned vehicle 2; and controlling the blinker 20 based on the blinker data when the operation data is acquired at the time when the unmanned vehicle 2 operates based on the travel course data.

[Other Embodiments]

In the above-described embodiment, the mode of the unmanned vehicle 2 is switched between the automatic mode and the manual mode. The mode of the unmanned vehicle 2 is not required to be switched between the automatic mode and the manual mode. For example, when the operation data of the blinker operation device 31 is acquired in the case where the unmanned vehicle 2 operates based on the travel course data in the unmanned vehicle 2 that does not have the automatic mode and the manual mode, such as a case where the manned vehicle 9 is operated as the unmanned vehicle 2, the blinker control unit 30D controls the blinker 20 based on the blinker data acquired by the travel course data acquisition unit 30B.

Note that, in the above-described embodiment, at least a part of the functions of the control device 30 of the unmanned vehicle 2 may be provided in the management device 3, or at least a part of the functions of the management device 3 may be provided in the control device 30.

Note that, in the above-described embodiment, the travel course data is generated in the management device 3, and the unmanned vehicle 2 travels in accordance with the travel course data transmitted from the management device 3. The control device 30 of the unmanned vehicle 2 may generate the travel course data. That is, the control device 30 may include the travel course data generation unit. Furthermore, each of the management device 3 and the control device 30 may include the travel course data generation unit.

Note that, in the above-described embodiment, the unmanned vehicle 2 is a dump truck, which is a type of transportation vehicle. The unmanned vehicle 2 may be a work machine including working equipment such as an excavator and a bulldozer.

### REFERENCE SIGNS LIST

1 CONTROL SYSTEM
2 UNMANNED VEHICLE
3 MANAGEMENT DEVICE
3A COMMUNICATION UNIT
3B TRAVEL COURSE DATA GENERATION UNIT
4 COMMUNICATION SYSTEM
5 CONTROL FACILITY
6 WIRELESS COMMUNICATION DEVICE
7 LOADER
8 CRUSHER
9 MANNED VEHICLE
20 BLINKER
21 TRAVEL DEVICE
22 VEHICLE BODY
23 DUMP BODY
24 DRIVE DEVICE
25 BRAKE DEVICE
26 STEERING DEVICE
27 WHEEL
27F FRONT WHEEL
27R REAR WHEEL
28 POSITION DETECTION DEVICE
29 WIRELESS COMMUNICATION DEVICE
30 CONTROL DEVICE
30A COMMUNICATION UNIT
30B TRAVEL COURSE DATA ACQUISITION UNIT
30C OPERATION DATA ACQUISITION UNIT
30D BLINKER CONTROL UNIT
30E TRAVEL CONTROL UNIT
31 BLINKER OPERATION DEVICE
32 TRAVEL OPERATION DEVICE
90 CONTROL DEVICE
91 WIRELESS COMMUNICATION DEVICE
Cr TARGET TRAVEL ROUTE
Cr1 TARGET TRAVEL ROUTE
Cr2 TARGET TRAVEL ROUTE
HL TRAVEL PATH
PA WORKPLACE
DPA DISCHARGING PLACE
LPA LOADING PLACE

1. A system of controlling an unmanned vehicle, the system comprising:
a travel course data acquisition unit that acquires travel course data including blinker data for controlling a blinker provided in an unmanned vehicle;
an operation data acquisition unit that acquires operation data of a blinker operation device provided in the unmanned vehicle; and
a blinker control unit that controls the blinker based on the blinker data acquired by the travel course data acquisition unit when the operation data is acquired by the operation data acquisition unit at a time when the unmanned vehicle operates based on the travel course data.

2. The system of controlling an unmanned vehicle according to claim 1, the system further comprising a travel control unit that controls travel of the unmanned vehicle based on the travel course data.

3. A method of controlling an unmanned vehicle, comprising:
acquiring travel course data including blinker data for controlling a blinker provided in an unmanned vehicle;
acquiring operation data of a blinker operation device provided in the unmanned vehicle; and
controlling the blinker based on the blinker data when the operation data is acquired at a time when the unmanned vehicle operates based on the travel course data.
